(19) United States
(12) Patent Application Publication
(10) Pub. No.: US 2026/0365252 A1
(43) Pub. Date: Nov. 19, 2026

(54) BODY

(71) Applicant: TOYOTA JIDOSHA KABUSHIKI KAISHA, Toyota-shi (JP)

(72) Inventors: Yukihiro HOSAKA, Toyota-shi (JP); Kyosuke INAYAMA, Okazaki-shi (JP); Akira MORIYAMA, Kariya-shi (JP)

(73) Assignee: TOYOTA JIDOSHA KABUSHIKI KAISHA, Toyota-shi (JP)

(21) Appl. No.: 19/657,299

(22) Filed: Apr. 24, 2026

(30) Foreign Application Priority Data
May 19, 2025 (JP) 2025-083443

(51) Int. Cl. B62D 25/16

(52) U.S. Cl. CPC B62D 25/163

(57) ABSTRACT

A body for a vehicle includes a frame member that extends above a wheel house in a front-rear direction of the vehicle, a fender panel that covers the frame member, and a fender bracket that is provided between the frame member and the fender panel. The fender bracket extends in a front-rear direction of the vehicle, and includes a first projection that projects toward a side away from the frame member, a first portion that extends from the first projection in a downward direction of the vehicle, and a second portion that extends from the first portion outward in a width direction of the vehicle. The frame member includes a flange portion that protrudes outward in the width direction of the vehicle. The second portion is disposed at a position facing the flange portion.

### CROSS-REFERENCE TO RELATED APPLICATION

This application claims priority to Japanese Patent Application No. 2025-083443 filed on May 19, 2025. The disclosure of the above-identified application, including the specification, drawings, and claims, is incorporated by reference herein in its entirety.

### BACKGROUND

### 1. Technical Field

The technology disclosed in the present specification relates to a body for a vehicle. In particular, the present specification relates to an attachment structure for a fender panel that covers a frame member of the body.

### 2. Description of Related Art

Japanese Unexamined Patent Application Publication No. 2018-039356 (JP 2018-039356 A) discloses a structure in which a fender bracket is interposed between a fender panel and a frame member, and the fender panel is attached to the frame member. The fender bracket of JP 2018-039356 A is provided with a planned deformation portion that protrudes toward an upper surface of the frame member. In a case where a pedestrian collides with a front side portion of a vehicle and a head of the pedestrian collides with the fender panel, the planned deformation portion of the fender bracket is pressed against the frame member of a vehicle body via the fender panel and is plastically deformed by a collision load. As a result, JP 2018-039356 A describes that collision energy is absorbed.

### SUMMARY

In JP 2018-039356 A, the contact area of the planned deformation portion of the fender bracket with respect to the frame member is extremely small. Therefore, the fender bracket cannot continuously bear the collision load, and efficient absorption of collision energy is difficult. The present specification provides a technology that enables collision energy to be efficiently absorbed by a fender bracket in an attachment structure of a fender panel.

The technology disclosed in the present specification is embodied in a body for a vehicle.
The body includes
a frame member that extends above a wheel house in a front-rear direction of the vehicle,
a fender panel that covers the frame member, and
a fender bracket provided between the frame member and the fender panel.
The fender bracket includes
a first projection that extends along the front-rear direction of the vehicle and projects toward a side away from the frame member,
a first portion that extends from the first projection in a downward direction of the vehicle, and
a second portion that extends from the first portion outward in a width direction of the vehicle.
The frame member includes a flange portion that protrudes outward in the width direction of the vehicle.
The second portion is disposed at a position facing the flange portion.

In the body, the fender bracket includes the first projection that projects toward a side away from the frame member. Therefore, in a case where a collision load is input to the fender panel, the collision load is first input to the first projection of the fender bracket via the fender panel. On the other hand, the second portion of the fender bracket is disposed at a position facing the flange portion of the frame member. Therefore, in a case where the fender panel is pressed by the collision load, the second portion comes into contact with the flange portion. In the body, since the second portion and the flange portion face each other, a large contact area between the second portion and the flange portion can be easily ensured. Therefore, the second portion and the flange portion can continuously bear the collision load. In addition, in the body, the second portion bears the collision load, and the first projection that is in contact with the fender panel deforms toward the frame member side, such that collision energy can be efficiently absorbed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a front perspective view of a vehicle;

FIG. 2 is a perspective view of a fender bracket;

FIG. 3 is a cross-sectional view of a vicinity of the fender bracket as viewed from a vehicle front side;

FIG. 4 is a diagram for describing a process in which the fender bracket is deformed; and

FIG. 5 is a diagram for describing a process in which the fender bracket is deformed.

### DETAILED DESCRIPTION OF EMBODIMENTS

In one embodiment of the present technology, the second portion may extend outward in the width direction of the vehicle beyond the flange portion. The fender bracket may further include a second projection that is connected to the second portion and projects toward a side away from the frame member, and a third portion that extends from the second projection along the downward direction of the vehicle to a lower side of the flange portion.

In a case where the collision load is input to the fender panel, the fender bracket may move so as to be shifted inward in the width direction of the vehicle together with the fender panel. According to the above configuration, the fender bracket includes the second projection that is connected to the second portion, and the third portion that extends from the second projection to the lower side of the flange portion. Therefore, in a case where the fender bracket moves inward in the width direction of the vehicle, the third portion is engaged with an end part of the flange portion on the outer side in the width direction of the vehicle. As a result, the movement of the fender bracket inward in the width direction of the vehicle is restricted. Therefore, the collision load can be more continuously applied by the second portion that comes into contact with the flange portion.

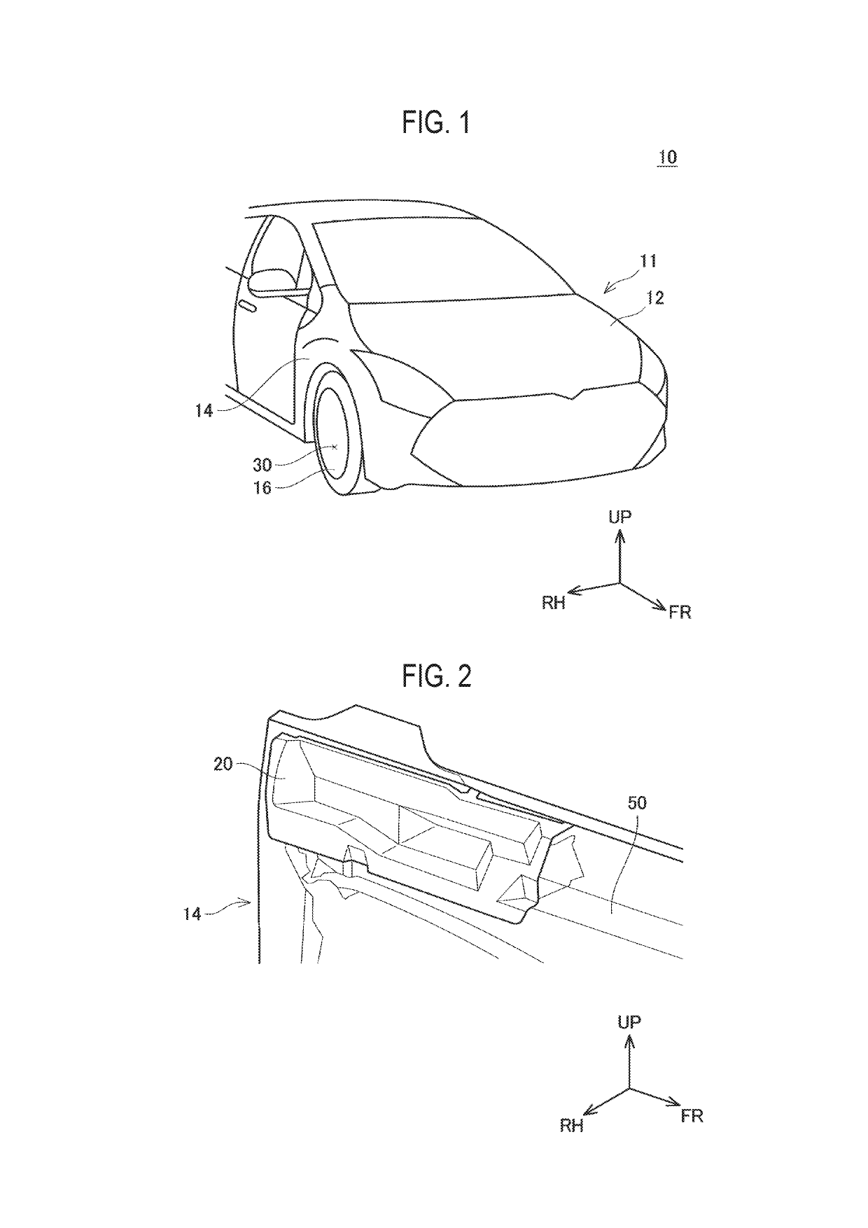

The vehicle 10 of the embodiment will be described with reference to the drawings. In each of the drawings, “FR” in the coordinate system indicates a front direction of the vehicle, “RH” indicates a right side in the width direction of the vehicle, and “UP” indicates an upward direction of the vehicle. As shown in FIG. 1, the vehicle 10 includes a body 11. A hood 12 that opens and closes an upper opening of an engine compartment is provided at a front portion of the vehicle 10, and a pair of fender panels 14 that are located on the outer side in the width direction of the vehicle of the hood 12 and that constitute an outer wall of the front portion of the vehicle 10 are provided. The fender panel 14 covers a wheel house 32 that stores a front wheel 16, and is manufactured by, for example, press-forming a steel plate. In FIG. 1, only the right fender panel 14 is shown.

Hereinafter, an attachment structure of the fender panel 14 will be described. Since the attachment structure of the fender panels 14 is right-left symmetrical, the attachment structure of the right fender panel 14 will be described below, and the attachment structure of the left fender panel 14 will be omitted.

As shown in FIG. 2, the fender panel 14 covers a frame member 50 that extends along the front-rear direction of the vehicle. The frame member 50 is provided above the wheel house 32 (see FIG. 1), and is also referred to as an upper member. In FIG. 2, for ease of understanding, the fender bracket 20 and the frame member 50 that are located on the vehicle interior side with respect to the fender panel 14 (that is, are not actually visible) are shown.

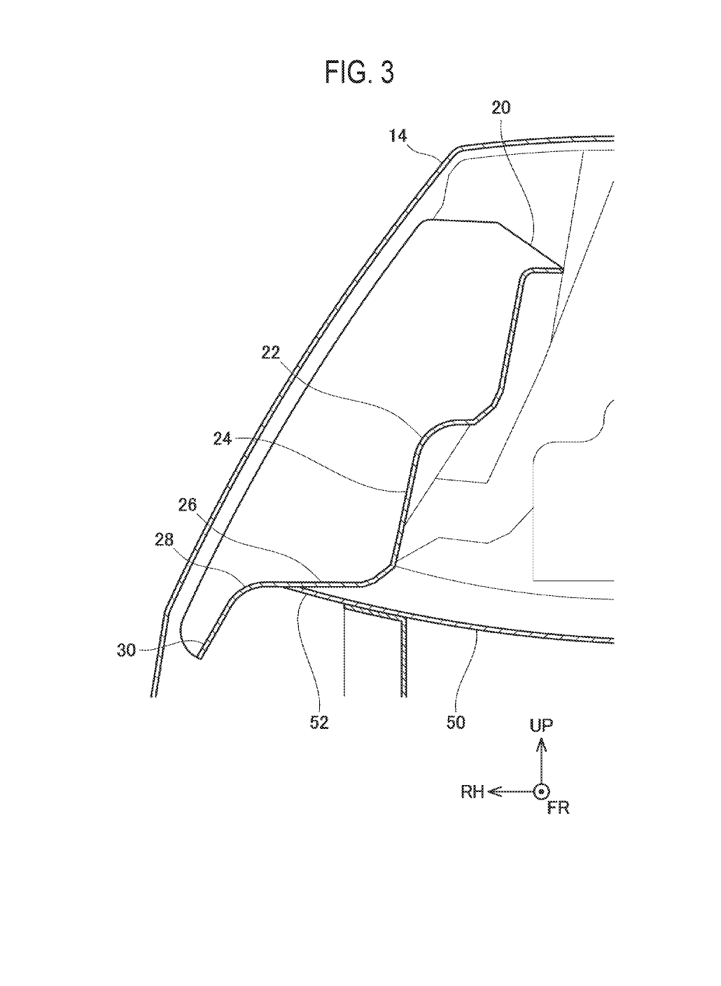

The fender bracket 20 is attached to the fender panel 14. As shown in FIG. 3, the fender bracket 20 is a plate-shaped member and has a step shape in a front view of the vehicle 10. In addition, although not shown, the fender bracket 20 is fixed to the fender panel 14 or the frame member 50 by, for example, spot welding or an adhesive around the periphery thereof. A thickness of the fender bracket 20 is not particularly limited, but can be, for example, equal to or larger than a thickness of the fender panel 14.

As shown in FIG. 3, the frame member 50 includes a flange portion 52. The flange portion 52 extends along the front-rear direction of the vehicle and protrudes outward in the width direction of the vehicle.

The fender bracket 20 includes a first projection 22, a first portion 24, a second portion 26, a second projection 28, and a third portion 30. Each of the portions 22 to 30 extends along the front-rear direction of the vehicle.

The first projection 22 has a shape that projects toward a side away from the frame member 50. The first projection 22 is located at a central portion of the fender bracket 20 in the vehicle up-down direction. The first portion 24 extends from the first projection 22 in a downward direction of the vehicle. The first portion 24 extends to the vicinity of the flange portion 52 of the frame member 50. The second portion 26 extends from a lower end of the first portion 24 outward in the width direction of the vehicle. The second portion 26 extends outward in the width direction of the vehicle beyond the flange portion 52 of the frame member 50. The second portion 26 is disposed at a position facing the flange portion 52, with a slight space between the second portion 26 and the flange portion 52. However, the second portion 26 may be disposed to be in contact with the flange portion 52. The second projection 28 is connected to an outer end part of the second portion 26. The second projection 28 has a shape that projects toward a side away from the frame member 50. The third portion 30 extends from the second projection 28 in a downward direction of the vehicle. The third portion 30 extends to a lower side of the flange portion 52. The third portion 30 is joined to the fender panel 14. As is clear from the above description and FIG. 3, a space is provided between the fender panel 14 and the fender bracket 20.

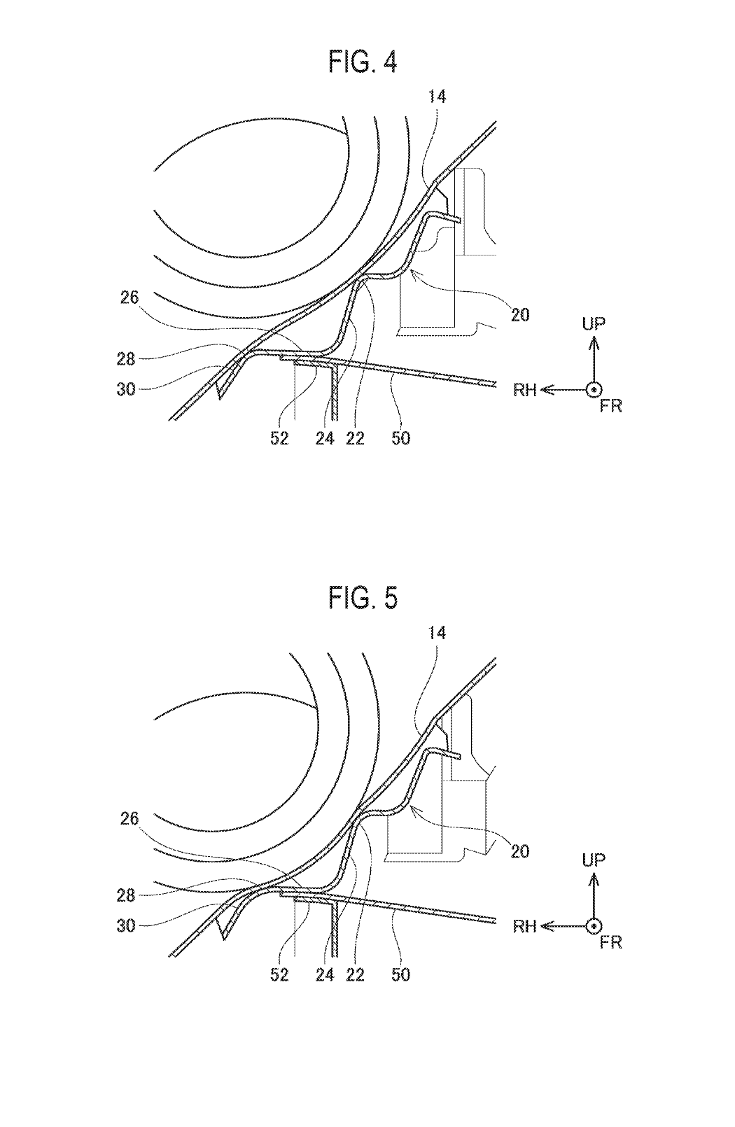

Next, the deformation of the fender bracket 20 in a case where the collision load is input from above to the front side portion of the vehicle 10 will be described with reference to FIGS. 4 and 5. In a case where the collision load is input to the fender panel 14, as shown in FIG. 4, the fender panel 14 is deformed to be pressed into the vehicle 10. In the vehicle 10 of the present embodiment, the first projection 22 of the fender bracket 20 has a shape that projects toward a side away from the frame member 50. Therefore, in a case where the collision load is input to the fender panel 14, the fender panel 14 comes into contact with the first projection 22 of the fender bracket 20. Therefore, the collision load is first input to the first projection 22 via the fender panel 14. On the other hand, the second portion 26 of the fender bracket 20 is disposed at a position facing the flange portion 52. Therefore, in a case where the fender panel 14 is pressed, the second portion 26 comes into contact with the flange portion 52. In the present embodiment, since the second portion 26 and the flange portion 52 extend long along the front-rear direction of the vehicle, the contact area between the second portion 26 and the flange portion 52 is large. Therefore, the collision load can be continuously applied by the second portion 26 and the flange portion 52. In addition, in a case where the first projection 22 is deformed to the frame member 50 side such that the projection shape of the first projection 22 is crushed in a state where the second portion 26 is in contact with the flange portion 52, the collision energy can be efficiently absorbed.

In addition, in a process in which the fender panel 14 is pressed, the fender bracket 20 may move so as to be shifted inward in the width direction of the vehicle. In a case where the fender bracket 20 itself moves significantly with respect to the vehicle 10, the absorption efficiency of the collision energy is reduced. However, the fender bracket 20 of the present embodiment includes the second projection 28 that is connected to the outer end part of the second portion 26, and the third portion 30 that extends from the second projection 28 to a lower side of the flange portion 52. Therefore, as shown in FIG. 5, in a case where the fender bracket 20 moves inward in the width direction of the vehicle, the third portion 30 is engaged with an end part of the flange portion 52 on the outer side in the width direction of the vehicle. As a result, the movement of the fender bracket 20 inward in the width direction of the vehicle is restricted. Therefore, the collision load can be efficiently applied by the second portion 26 that comes into contact with the flange portion 52.

In the embodiment, the second portion 26 may not extend outward in the width direction of the vehicle beyond the flange portion 52. In addition, the fender bracket 20 may not include the second projection 28 and the third portion 30.

Although specific examples of the technology disclosed in the present specification have been described in detail above, these examples are merely illustrative and do not limit the scope of the claims. The technology described in the claims includes various modifications and changes of the specific examples illustrated above. In addition, the technical elements described in the present specification or the drawings exhibit technical usefulness alone or in various combinations and are not limited to the combinations described in the claims at the time of filing. Further, the technology exemplified in the present specification or the drawings achieves a plurality of objectives at the same time, and achieving one of the objectives has technical usefulness.

What is claimed is:

1. A body for a vehicle, the body comprising:
a frame member that extends above a wheel house in a front-rear direction of the vehicle;
a fender panel that covers the frame member; and
a fender bracket provided between the frame member and the fender panel, wherein:
the fender bracket includes
a first projection that extends along the front-rear direction of the vehicle and projects toward a side away from the frame member,
a first portion that extends from the first projection in a downward direction of the vehicle, and
a second portion that extends from the first portion outward in a width direction of the vehicle;
the frame member includes a flange portion that protrudes outward in the width direction of the vehicle; and
the second portion is disposed at a position facing the flange portion.

2. The body according to claim 1, wherein:
the second portion extends outward in the width direction of the vehicle beyond the flange portion; and
the fender bracket further includes
a second projection that is connected to the second portion and projects toward a side away from the frame member, and
a third portion that extends from the second projection in a downward direction of the vehicle to a position below the flange portion.
